(19) United States
(12) Patent Application Publication
(10) Pub. No.: US 2021/0319411 A1
(43) Pub. Date: Oct. 14, 2021

(54) SYSTEMS AND METHODS FOR TRACKING EQUIPMENT LIFETIMES AND GENERATING HISTORY REPORTS TO THE SAME

(71) Applicant: Blockchain FOB, Ball Ground, GA (US)

(72) Inventors: Jeff Tyler, Woodstock, GA (US); David Bishop, Woodstock, GA (US); Larry Shane Neighbors, Talking Rock, GA (US); Charles E. Mason, III, Cumming, GA (US)

(21) Appl. No.: 17/226,527

(22) Filed: Apr. 9, 2021

Related U.S. Application Data
(60) Provisional application No. 63/007,406, filed on Apr. 9, 2020.

(51) Int. Cl. G06Q 10/00; G06F 21/62; G06Q 30/00

(52) U.S. Cl. CPC G06Q 10/20; G06Q 30/0185; G06F 21/6209

(57) ABSTRACT

Disclosed herein are digitalized blockchain-enabled asset tracking systems and methods to provide manufacturers, and other participants, with complete provenance of equipment in the system. This can include information such as location, ownership, warranties, service agreements, service history, and equipment status. The other participants in the system can also have the ability to add and/or modify immutable records, depending on the permissions assigned to each of the participants. Additionally, the disclosed systems and methods can generate history reports for each equipment unit registered with the system. The history reports can outline the entire equipment history, including all information written to the system during the equipment lifetime. In such a manner, the record of the equipment is stored in a singular, uniform format where it is easily accessible.

### CROSS-REFERENCE TO RELATED APPLICATIONS

This application claims the benefit of U.S. Provisional Application Ser. No. 63/007,406, filed on 9 Apr. 2020, the entire contents and substance of which is incorporated herein by reference in its entirety as if fully set forth below.

### FIELD OF THE DISCLOSURE

The present disclosure relates generally to systems and methods for tracking equipment lifetimes. Particularly, embodiments of the present disclosure relate to blockchain-enabled equipment tracking systems and methods.

### BACKGROUND

Equipment such as appliances and industrial-grade process assets are subject to a variety of transactions in their lifetimes. Manufacturers, owners, distributors, dealers, storage facilities, installers, and maintenance personnel have needed the ability to track and update products throughout the products' entire lifecycle including location, ownership, warranties, service agreements, service history, and status. As such, records of such appliances were often maintained in physical paper form. These records often took the form of whichever participant last updated the records. Currently, the asset data, even digitally, is maintained in disparate systems within each individual participant's asset management tracking—if they even have such a formal system. Naturally, equipment is often exchanged, transferred, or transitioned between locations or maintained without proper records.

As will be appreciated, such haphazard record keeping can create maintenance issues and/or general distrust of appliances on the market. Without uniform, validated records of asset lifetimes, neither a buyer nor a seller of such equipment can confirm the authenticity of the equipment. Any participant having an interest in the equipment must go on a time-consuming and resource-intensive search for the proper records, which are often in such disparate formats that they are unreliable. Additionally, if equipment actually is faulty with no record indicating it as such, it can pose a safety hazard to individuals working in close proximity to the equipment.

### BRIEF SUMMARY OF THE DESCRIPTION

The subject of the disclosed technology relates to a centralized and immutable system or method for assets, such as appliances, that can track the entire provenance of equipment throughout its lifetime as well as other related needs that will become apparent upon reading the description below in conjunction with the drawings. The following presents a summary of the innovation to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later. The subject disclosure generally pertains to systems and methods for tracking equipment lifetimes. Particularly, embodiments of the present disclosure relate to blockchain-enabled equipment tracking systems and methods.

An embodiment of the present disclosure can provide a method of tracking equipment lifetimes, the method comprising: responsive to receiving an indication of an asset, generating, by a computing device, an asset blockchain ledger in a blockchain network, the asset blockchain ledger associated with an identification number; receiving, at the computing device and from a first computing device associated with a first participant, first data indicative of a first transaction corresponding to the asset; receiving, from a second computing device associated with a second participant, second data indicative of the first transaction corresponding to the asset; generating, by the computing device and in the asset blockchain ledger associated with the identification number, a first block associated with the first transaction; determining, by the computing device, a first set of permissions associated with the first participant and a second set of permissions associated with the second participant; transmitting, from the computing device and based at least in part on the first set of permissions, and to the first computing device, a request for a first unreceived information from the first participant relating to the first transaction; transmitting, from the computing device and based at least in part on the second set of permissions, and to the second computing device, a request for a second unreceived information from the second participant relating to the first transaction; receiving, at the computing device, and from the first computing device and the second computing device, data representative of a response to the request for the first and the second unreceived information from each of the first participant and the second participant, respectively; responsive to determining that the data representative of the response received from the first participant and the second participant comprises the first and the second unreceived information, respectively, writing, in the blockchain network, the first transaction to a first block of the asset blockchain, the first block comprising participation data and the data representative of the response; receiving, at the computing device, a request for a history report associated with at least one of the identification number or the asset; and generating the history report associated with the identification number and the asset, the history report comprising the first transaction.

The request for the first unreceived information and the request for the second unreceived information can each comprise a prompt for each of the first participant and the second participant to scan a code on the asset, the code representative of the identification number.

The first transaction can comprise one of: a product sale, a product maintenance, a product install, a product removal, or a product modification. Alternatively, or in addition, the first transaction can comprise one of: a product valuation, a product warranty, a product service record, or a product service agreement. The first participant and the second participant can be selected from one or more of: a manufacturer, a distributor, a shipper, a service agent, a storage entity, a dealer, an installer, or an owner.

The method can further comprise receiving location data for the first transaction; generating, by the computing device and in the asset blockchain ledger associated with the identification number, a second block associated with the first transaction; and writing the location data to the second block of the asset blockchain ledger, wherein the second block comprises an indication that the location data is associated with the first block.

The method can further comprise determining that the data representative of the response to request for the first unreceived information and the second unreceived information do not match; transmitting an error message to each of the first participant and the second participant, the error message comprising the identification number, the first data, and the second data from the first transaction; receiving, at the computing device, and from the first computing device and the second computing device, data representative of a response to the error message from each of the first participant and the second participant; and responsive to determining that the response to the error message received from the first participant and the second participant matches, writing, in the blockchain network, the response to the error message to the first block of the asset blockchain.

The method can further comprise updating the second set of permissions corresponding to the second participant, wherein the update comprises an indication that the second participant is the most recent owner of the asset. Additionally, the method can further comprise dynamically transmitting the generated history report to each of the first participant and the second participant.

Another embodiment of the present disclosure can provide a method for tracking equipment lifetimes, the method comprising: responsive to receiving an indication of an asset, generating, by a computing device, an asset blockchain ledger in a blockchain network, the asset blockchain ledger associated with an identification number; receiving, at the computing device and from a first computing device associated with a first participant, first data indicative of a first transaction corresponding to the asset; generating, by the computing device and in the asset blockchain ledger associated with the identification number, a first block associated with the first transaction; determining, by the computing device, a first set of permissions associated with the first participant; transmitting, by the computing device and based at least in part on the first set of permissions, and to the first computing device, a request for a first unreceived information from the first participant relating to an activity being completed by the first participant; receiving, at the computing device, and from the first computing device, an indication from the first participant that the first unreceived information has been received and the activity is complete; responsive to receiving the first unreceived information, writing, in the blockchain network, the first transaction and the activity to a first block of the asset blockchain; receiving, at the computing device, a request for a history report associated with the identification number and the asset; and generating the history report associated with the identification number and the asset, the history report comprising the first transaction and the activity.

The method can further comprise, responsive to receiving the indication that the request has been fulfilled, sending a confirmation request to the first participant, the confirmation request including a prompt for evidence from the first participant. The prompt for evidence can comprise a prompt for one or more of: a photograph of the asset, a signature from the first participant, a voice recording from the first participant, a video of actions performed, or a document scan of the activity.

The method can further comprise receiving an indication from the first participant of a corrective action implemented on the asset, the corrective action comprising one or more of: replacing a part, restarting a component, resetting a component, restarting the asset, shutting down the asset, or recalibrating a part.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

Aspects of the disclosure are understood from the following detailed description when read with the accompanying drawings. It will be appreciated that elements, structures, etc. of the drawings are not necessarily drawn to scale. Accordingly, the dimensions of the same may be arbitrarily increased or reduced for clarity of discussion, for example.

FIG. 1 is a flowchart of a method of tracking equipment lifetimes, in accordance with some examples of the present disclosure.

FIG. 2 is a flowchart of a method of tracking equipment lifetimes, in accordance with some examples of the present disclosure.

FIG. 3 is a flowchart of a method for generating equipment history reports, in accordance with some examples of the present disclosure.

FIG. 4 is a component diagram of a system for tracking equipment lifetimes, in accordance with some examples of the present disclosure.

FIG. 5 is a component diagram of a computing device used in the systems for tracking equipment lifetimes, in accordance with some examples of the present disclosure.

FIG. 6 is a timing diagram of a method and system for tracking equipment lifetimes, in accordance with some examples of the present disclosure.

### DETAILED DESCRIPTION

As stated above, a problem with current efforts at maintaining records of and tracking an asset over its lifetime is that records of such appliances are often maintained in physical paper form. These records often can take whatever form deemed appropriate by the participant (e.g., owner, manufacturer, buyer, seller, maintenance worker, etc.) creating the record. Even digital record keeping and asset tracking is maintained in disparate systems within each individual participant. Equipment is often exchanged, transferred, or transitioned between locations or maintained without proper records. This can create maintenance issues and/or general distrust of appliances on the market. Without uniform, validated records of asset lifetimes, neither a buyer nor a seller of such equipment can confirm the authenticity of the equipment.

Disclosed herein are digitalized blockchain-enabled asset tracking systems and methods to provide manufacturers, and other participants, with complete provenance of equipment in the system. This can include information such as location, ownership, warranties, service agreements, service history, and equipment status. The other participants in the system can also have the ability to add and/or modify immutable records, depending on the permissions assigned to each of the participants. Additionally, the disclosed systems and methods can generate history reports for each equipment unit registered with the system. The history reports can outline the entire equipment history, including all information written to the system during the equipment lifetime. In such a manner, the record of the equipment is stored in a singular, uniform format where it is easily accessible.

The disclosed technology can use blockchain technology to create a distributed ledger that can serve as a centralized repository for maintaining equipment records. The disclosed technology can allow participants to add, remove, or modify the records based on permissions assigned to the participants. Each participant type can have different permissions that enable them to modify the records requisite to their role. Participants can use the history report generated by the system to answer all questions they have about their equipment assets, including status, location, ownership, service history, and specifications. The disclosed technology can be used to track assets or equipment in any industries or fields where said assets may be touched by a variety of stakeholders throughout its lifecycle and complete provenance is a critical need and difficult to obtain.

Although certain embodiments of the disclosure are explained in detail, it is to be understood that other embodiments are contemplated. Accordingly, it is not intended that the disclosure is limited in its scope to the details of construction and arrangement of components set forth in the following description or illustrated in the drawings. Other embodiments of the disclosure are capable of being practiced or carried out in various ways. Also, in describing the embodiments, specific terminology will be resorted to for the sake of clarity. It is intended that each term contemplates its broadest meaning as understood by those skilled in the art and includes all technical equivalents which operate in a similar manner to accomplish a similar purpose.

Herein, the use of terms such as “having,” “has,” “including,” or “includes” are open-ended and are intended to have the same meaning as terms such as “comprising” or “comprises” and not preclude the presence of other structure, material, or acts. Similarly, though the use of terms such as “can” or “may” are intended to be open-ended and to reflect that structure, material, or acts are not necessary, the failure to use such terms is not intended to reflect that structure, material, or acts are essential. To the extent that structure, material, or acts are presently considered to be essential, they are identified as such.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified.

The components described hereinafter as making up various elements of the disclosure are intended to be illustrative and not restrictive. Many suitable components that would perform the same or similar functions as the components described herein are intended to be embraced within the scope of the disclosure. Such other components not described herein can include, but are not limited to, for example, similar components that are developed after development of the presently disclosed subject matter.

Various aspects of the subject disclosure are now described in more detail with reference to the annexed drawings, wherein like numerals generally refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

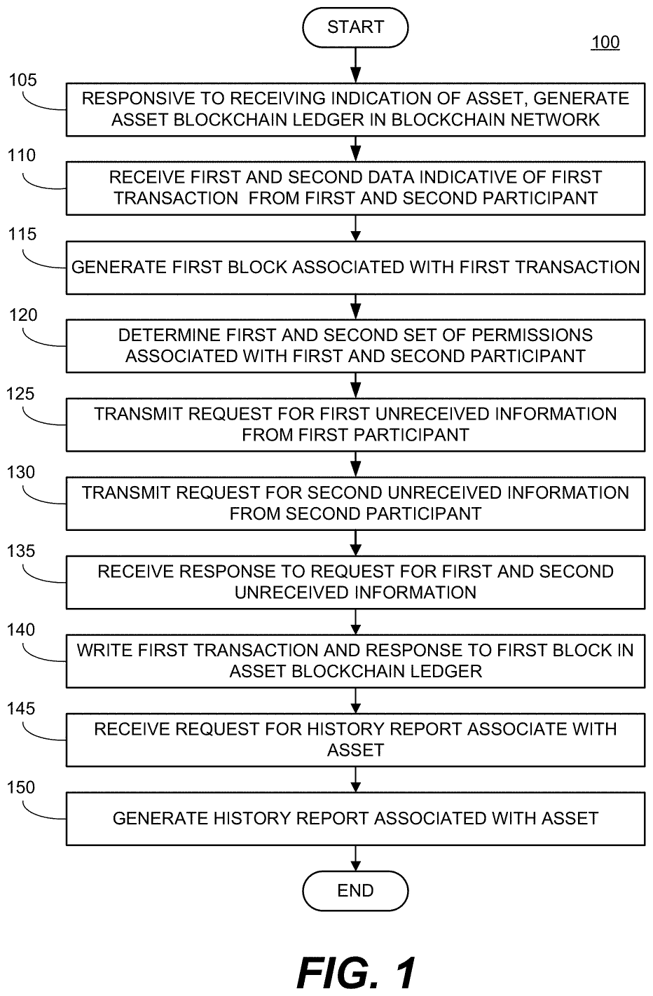

FIG. 1 illustrates an example method 100 of tracking equipment lifetimes. As shown, the computing device can generate 105 an asset blockchain ledger in a blockchain network. For example, the computing device can generate the asset blockchain ledger responsive to receiving an indication of an asset. The indication of the asset can be related to the manufacture/creation of an asset, or the indication of the asset can be related to the registration/entry of an asset into the blockchain network. The asset blockchain ledger can be associated with an identification number, such as a serial number of the asset. The identification number also can include other information, such as unique identifying numbers, QR codes, barcodes, and the like. Examples of a computing device, an asset blockchain ledger, and a blockchain network are described in further detail below.

As further shown, the computing device can receive 110, from a first computing device associated with a first participant, first data indicative of a first transaction corresponding to the asset (i.e., the system can learn that something relating to the asset has occurred). The first transaction can comprise, for example, a product sale, a product maintenance, a product install, a product removal, or a product modification. The first transaction can further comprise, for instance, a product valuation, a product warranty, a product service record, or a product service agreement. The first participant can be one of a group of participants associated with the blockchain network. For example, the first participant can be a manufacturer, a distributor, a shipper, a service agent, a storage entity, a dealer, an installer, or an owner.

The computing device can further receive, from a second computing device associated with a second participant, second data indicative of the first transaction corresponding to the asset. The second participant can also be one of a group of participants associated with the blockchain network. The first and the second participants can be individuals associated with the same entity. For example, the first and the second participant can both be service technicians under the same manufacturer. Alternatively, the first and the second participant can be representative of separate entities.

As further shown in FIG. 1, in some implementations, the computing device then can generate 115, in the asset blockchain ledger associated with the identification number of the asset, a first block associated with the first transaction. As will be understood by one of skill in the art, a system of the present disclosure can generate the first block through any standard method for generating blocks in a blockchain ledger. The first block can be generated by the computing device and/or the blockchain network itself.

The computing device further can determine 120 a first set of permissions associated with the first participant and a second set of permissions associated with the second participant, as applicable. The sets of permissions can be assigned to the first and second participants upon generation of the permissions, or the first and second sets of permissions can be assigned when the first and second participants enter the blockchain network. In other words, each participant in the blockchain network can have permissions assigned thereto, the permissions defining a level of access of each participant to the asset blockchain ledger. For example, a participant can have read and write permissions to the asset blockchain ledger, while another participant may only have read permissions. The permissions can also control how much data can be read by each of the participants. In such a manner, the centralized asset blockchain ledger can be maintained by reducing the number of participants who are able to write and/or otherwise alter the asset blockchain ledger. In some examples, the computing device can update the permissions of the first and/or the second participants. For example, if the first transaction is a sale from the first participant to the second participant, the computing device can update the second set of permissions associated with the second participant to indicate that the second participant is the most recent owner of the asset.

As further shown, the computing device can transmit 125 a request to a participant for unreceived information relating to the first transaction. In some implementations, and as situationally necessary the computing device similarly can transmit 130 a request to the second participant for unreceived information relating to the first transaction. The unreceived information can include, for example, a prompt for a photograph of the asset, a prompt to scan the identification number on the asset, a prompt to scan a code on the asset that can represent the identification number, information about the transaction that is missing (e.g., date, time, location), the type of transaction, the identity of the first or second participant, and the like. In generally, unreceived information can constitute any information that further describes, confirms, validates, or otherwise relates to a transaction.

As further shown in FIG. 1, the computing device can receive 135 data representative of a response to the request for the first and the second unreceived information from each of the first participant and the second participant, respectively. In some implementations, and as applicable, the computing device can then determine if the data from the first participant and the data from the second participant match. That is, if the data do not match, there may be an error in the first transaction or a fraudulent transaction (e.g., if the first and second participants are a buyer and a seller and provide conflicting sale price information). In such a manner, the method 100 can ensure that only correct or confirmed data ultimately is written to the asset blockchain ledger. If the computing device determines that the data representative of the response to request for the first and second unreceived information do not match, the computing device can output an error message to each of the first participant and the second participant. The error message can comprise the identification number of the asset, the first and second data, and the first transaction. The computing device can then receive data representative of a response to the error message from each of the first participant and the second participant. The computing device can then make another determination if the data match.

In some implementations, the computing device can, in response to determining that the data representative of a response from the first and the second participants comprises the unreceived information, and that the responses match, write 140 the first transaction to a first block of the asset blockchain ledger, as shown in FIG. 1. The first block can comprise participation data for the first and second participants, as well as transaction data for the first transaction, data representative of the responses from the first and second participants, the unreceived information, and other information.

Should the computing device receive data relating to the first transaction after the fact (i.e., after the block relating to the transaction is written), the computing device can write such data to a second block in the asset blockchain ledger. For instance, after writing the block relating to the transaction, the computing device can later receive location data for the first transaction. In such an instance, the computing device can generate a second block associated with the first transaction in the asset blockchain ledger associated with the identification number. The computing device can then write the location data to the second block of the asset blockchain ledger. The location data can also include an indication that the location data is associated with the transaction data of the first block.

As is shown in FIG. 1, in some implementations, the computing device can receive 145 a request for a history report associated with at least one of the identification number and the asset. The request can come from a participant in the blockchain network (e.g., the first or second participant), or the request can be received from an external third party (i.e., a party that has not contributed to the blockchain relating to the asset). The request also can be filtered such that only participants with permissions to view history reports can request the history report of assets in the blockchain network. Alternatively, the system can generate a history report that reflects only certain information from the blockchain as opposed to a history report that includes all information stored in the blockchain relating to the asset.

The computing device can generate 150 the history report associated with the identification number and the asset. The history report can comprise the first transaction from the first block, as well as any and all blocks in the asset blockchain ledger associated with the asset. Alternatively, or in addition, the computing device can dynamically output the generated history report for delivery to the requester of the report (e.g., each of the first participant and the second participant). In other words, in some implementations, an update to the ledger can trigger the computing device to generate and transmit a history report without receiving a request. In such a manner, the computing device can keep participants apprised of changes to the history report. The method 100 can terminate after generating the history report or, in some examples, the method 100 can proceed to other method steps not shown, other methods disclosed herein, and/or other blocks of the method 100.

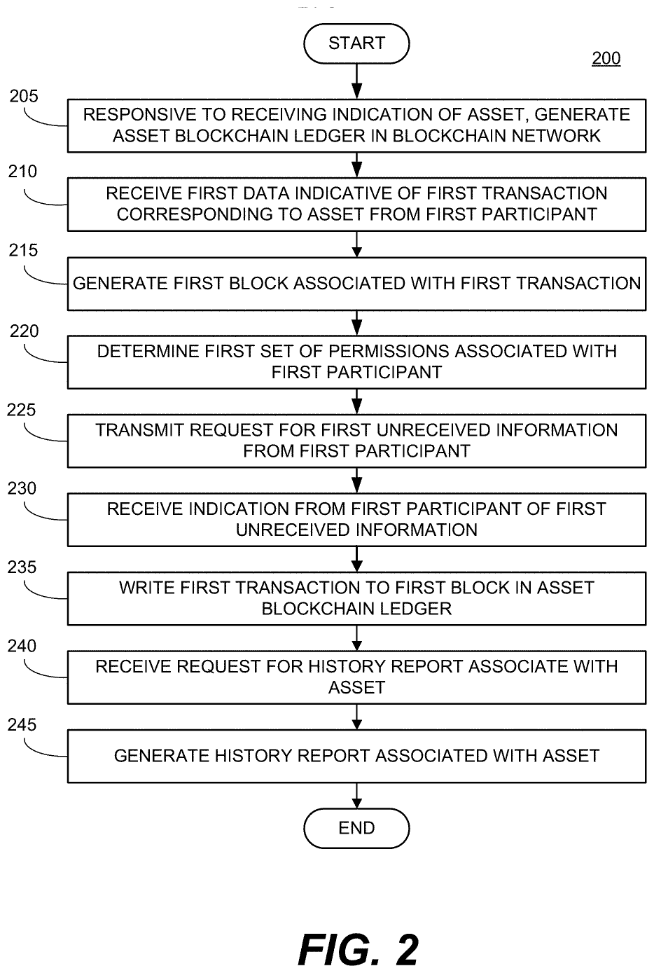

FIG. 2 illustrates an example method 200 of tracking equipment lifetimes. As shown in block 205, the computing device can generate, by a computing device, an asset blockchain ledger in a blockchain network. The computing device can generate the asset blockchain ledger responsive to receiving an indication of an asset. The indication of the asset can be related to the manufacture/creation of an asset, or the indication of the asset can be related to the registration/entry of an asset into the blockchain network. The asset blockchain ledger can be associated with an identification number, such as a serial number of the asset. The identification number can also include other information, such as unique identifying numbers, QR codes, barcodes, and the like. Examples of a computing device, an asset blockchain ledger, and a blockchain network are described in further detail below. The method 200 can then proceed on to block 210.

As shown in block 210, the computing device can receive, at the computing device and from a first computing device associated with a first participant, first data indicative of a first transaction corresponding to the asset. The first transaction can comprise, for example, a product sale, a product maintenance, a product install, a product removal, or a product modification. The first transaction can further comprise, for instance, a product valuation, a product warranty, a product service record, or a product service agreement. The first participant can be one of a group of participants associated with the blockchain network. For example, the first participant can be a manufacturer, a distributor, a shipper, a service agent, a storage entity, a dealer, an installer, or an owner. The method 200 can then proceed on to block 215.

As shown in block 215, the computing device can generate, in the asset blockchain ledger associated with the identification number of the asset, a first block associated with the first transaction. The first block can be generated through any standard method for generating blocks in a blockchain ledger. The first block can be generated by the computing device and/or the blockchain network itself. The method 200 can then proceed on to block 220.

As shown in block 220, the computing device can determine a first set of permissions associated with the first participant. The set of permissions can be assigned to the first participant in block 220, or the first set of permissions can be assigned when the first participant enters the blockchain network. In other words, each participant in the blockchain network can have permissions assigned thereto, the permissions defining a level of access of each participant to the asset blockchain ledger. For example, a participant can have read and write permissions to the asset blockchain ledger, while another participant may only have read permissions. The permissions can also control how much data can be read by each of the participants. In such a manner, the centralized asset blockchain ledger can be maintained by reducing the number of participants who are able to write and/or otherwise alter the asset blockchain ledger. In some examples, the computing device can update the permissions of the first participant. For example, if the first transaction is maintenance performed by the first participant on the asset, the computing device can update the first set of permissions associated with the first participant to indicate that the first participant is the most recent maintenance technician of the asset. The method 200 can then proceed on to block 225.

As shown in block 225, the computing device can transmit a request for a first unreceived information from the first participant relating to the first transaction. The unreceived information can include, for example, a prompt for a photograph of the asset, a prompt to scan the identification number on the asset, a prompt to scan a code on the asset that can represent the identification number, information about the transaction that is missing (e.g., date, time, location), the type of transaction, the identity of the first or second participant, and the like. The unreceived information can also include one or more activities to be performed by the first participant. For example, if the first participant is a service technician, the request for unreceived information can comprise a list of service activities to be performed on the asset. The method 200 can then proceed to block 230.

As shown in block 230, the computing device can receive an indication from the first participant that the first unreceived information has been received. The indication can also include an indication that the one or more activities to be performed by the first participant are complete. The computing device can also receive an indication from the first participant of a corrective action implemented on the asset. The corrective action can include, for example, replacing a part, restarting a component, resetting a component, restarting the asset, shutting down the asset, or recalibrating a part. Responsive to receiving the first unreceived information, the computing device can send a confirmation request to the first participant. The confirmation request can include a prompt for evidence from the first participant. The prompt for evidence can comprise, for example, a photograph of the asset, a signature from the first participant, a voice recording from the first participant, a video of actions performed, or a document scan of the activity. In such a manner, the first transaction can be confirmed by the first participant. In such a manner, the method 200 can also ensure that only correct data gets written to the asset blockchain ledger. The method 200 can then proceed to block 235.

As shown in block 235, the computing device can, in response to receiving the first unreceived information, write the first transaction to a first block of the asset blockchain ledger. The first block can comprise the one or more activities performed by the first participant, as well as transaction data for the first transaction, data representative of the responses from the first participant, the unreceived information, and other information, such as the corrective actions.

Should the computing device receive data relating to the first transaction after the fact, the computing device can write such data to a second block in the asset blockchain ledger. For instance, the computing device can receive location data for the first transaction. Then, the computing device can generate a second block associated with the first transaction in the asset blockchain ledger associated with the identification number. The computing device can then write the location data to the second block of the asset blockchain ledger. The location data can also include an indication that the location data is associated with the transaction data of the first block. The method 200 can then proceed to block 240.

As shown in block 240, the computing device can receive a request for a history report associated with at least one of the identification number or the asset. The request can come from a participant in the blockchain network, or the request can be received from an external third party. The request can also be filtered such that only participants with permissions to view history reports can request the history report of assets in the blockchain network. The method 200 can then proceed to block 245.

As shown in block 245, the computing device can generate the history report associated with the identification number and the asset. The history report can comprise the first transaction from the first block, as well as any and all blocks in the asset blockchain ledger associated with the asset. Alternatively, or in addition, the computing device can dynamically transmit the generated history report to the first participant. In other words, the computing device can transmit the generated history report without receiving a request. In such a manner, the computing device can keep participants apprised of changes to the history report. The method 200 can terminate after block 245; however, in some examples, the method 200 can proceed to other method steps not shown, other methods disclosed herein, and/or other blocks of the method 200.

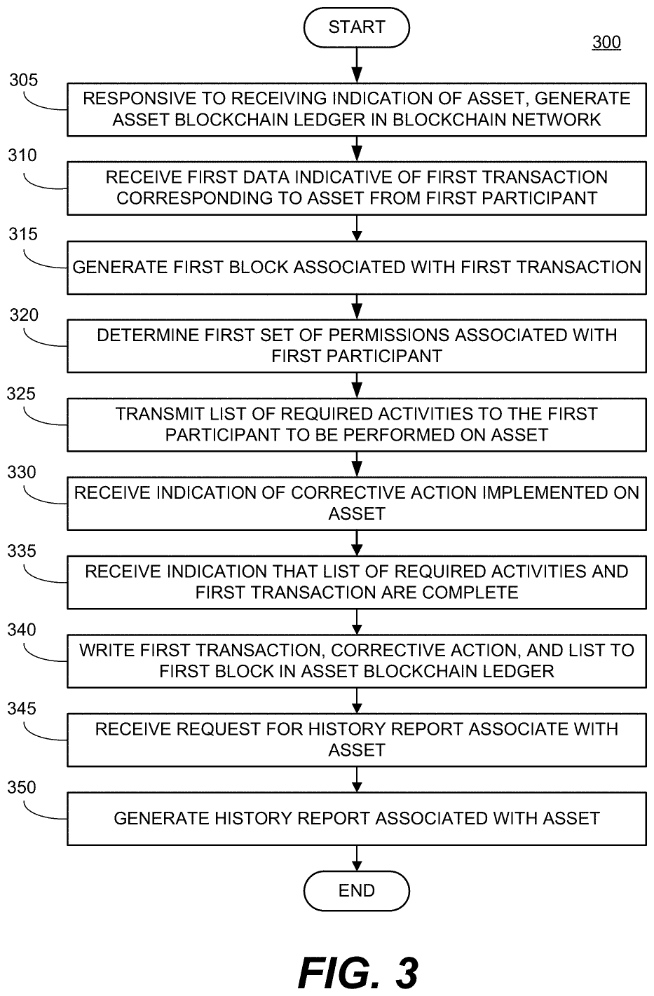

FIG. 3 illustrates an example method 300 of generating equipment history reports. As shown in block 305, the computing device can generate, by a computing device, an asset blockchain ledger in a blockchain network. The computing device can generate the asset blockchain ledger responsive to receiving an indication of an asset. The indication of the asset can be related to the manufacture/creation of an asset, or the indication of the asset can be related to the registration/entry of an asset into the blockchain network. The asset blockchain ledger can be associated with an identification number, such as a serial number of the asset. The identification number can also include other information, such as unique identifying numbers, QR codes, barcodes, and the like. Examples of a computing device, an asset blockchain ledger, and a blockchain network are described in further detail below. The method 300 can then proceed on to block 310.

As shown in block 310, the computing device can receive, at the computing device and from a first computing device associated with a first participant, first data indicative of a first transaction corresponding to the asset. The first transaction can comprise, for example, a product sale, a product maintenance, a product install, a product removal, or a product modification. The first transaction can further comprise, for instance, a product valuation, a product warranty, a product service record, or a product service agreement. The first participant can be one of a group of participants associated with the blockchain network. For example, the first participant can be a manufacturer, a distributor, a shipper, a service agent, a storage entity, a dealer, an installer, or an owner. The method 300 can then proceed on to block 315.

As shown in block 315, the computing device can generate, in the asset blockchain ledger associated with the identification number of the asset, a first block associated with the first transaction. The first block can be generated through any standard method for generating blocks in a blockchain ledger. The first block can be generated by the computing device and/or the blockchain network itself. The method 300 can then proceed on to block 320.

As shown in block 320, the computing device can determine a first set of permissions associated with the first participant. The set of permissions can be assigned to the first participant in block 320, or the first set of permissions can be assigned when the first participant enters the blockchain network. In other words, each participant in the blockchain network can have permissions assigned thereto, the permissions defining a level of access of each participant to the asset blockchain ledger. For example, a participant can have read and write permissions to the asset blockchain ledger, while another participant may only have read permissions. The permissions can also control how much data can be read by each of the participants. In such a manner, the centralized asset blockchain ledger can be maintained by reducing the number of participants who are able to write and/or otherwise alter the asset blockchain ledger. In some examples, the computing device can update the permissions of the first participant. For example, if the first transaction is maintenance performed by the first participant on the asset, the computing device can update the first set of permissions associated with the first participant to indicate that the first participant is the most recent maintenance technician of the asset. The method 300 can then proceed on to block 325.

As shown in block 325, in some implementations, the computing device can transmit a list of required activities indicative of actions relating to the first transaction. As will be understood by one of skill in the art, different transactions can require certain activities. For example, in the case of a transaction that is a specific maintenance activity to be performed on the asset, the list of activities can include, for example, cleaning, testing, replacing parts, and the like. The list of required activities can also include prompts for information, such as a prompt for a photograph of the asset or a photograph showing installation of a replacement part, a prompt to scan the identification number on the asset to scan a code on the asset that can represent the identification number to confirm the participant is engaging with the proper asset, information about the transaction that is missing (e.g., date, time, location), the type of transaction, the identity of the first participant, and the like. The method 300 can then proceed to block 330.

As shown in block 330, the computing device can receive an indication from the first participant of one or more corrective actions performed on the asset. The corrective action can include, for example, replacing a part, restarting a component, resetting a component, restarting the asset, shutting down the asset, or recalibrating a part. Responsive to receiving the indication of a corrective action, the computing device can send a confirmation request to the first participant. The confirmation request can include a prompt for evidence from the first participant. The prompt for evidence can comprise, for example, a photograph of the asset, a signature from the first participant, a voice recording from the first participant, a video of actions performed, or a document scan of the activity. In such a manner, the first transaction can be confirmed by the first participant. In such a manner, the method 300 can also ensure that only correct data gets written to the asset blockchain ledger. The method 300 can then proceed to block 335.

As shown in block 335, the computing device can receive an indication from the first participant that the list of required activities has been completed. Responsive to receiving the indication that the list of activities is complete, the computing device can send a confirmation request to the first participant. The confirmation request can include a prompt for evidence from the first participant. The prompt for evidence can comprise, for example, a photograph of the asset, a signature from the first participant, a voice recording from the first participant, a video of actions performed, or a document scan of the activity. In such a manner, the first transaction can be confirmed by the first participant. The method 300 can then proceed to block 340.

As shown in block 340, the computing device can, in response to receiving the completed list of activities, write the first transaction to a first block of the asset blockchain ledger. The first block can comprise the one or more activities performed by the first participant, as well as transaction data for the first transaction, data representative of the responses from the first participant, the unreceived information, and other information, such as the corrective actions.

Should the computing device receive data relating to the first transaction after the fact, the computing device can write such data to a second block in the asset blockchain ledger. For instance, the computing device can receive location data for the first transaction. Then, the computing device can generate a second block associated with the first transaction in the asset blockchain ledger associated with the identification number. The computing device can then write the location data to the second block of the asset blockchain ledger. The location data can also include an indication that the location data is associated with the transaction data of the first block. The method 300 can then proceed to block 345.

As shown in block 345, the computing device can receive a request for a history report associated with at least one of the identification number or the asset. The request can come from a participant in the blockchain network, or the request can be received from an external third party. The request can also be filtered such that only participants with permissions to view history reports can request the history report of assets in the blockchain network. The method 300 can then proceed to block 350.

As shown in block 350, the computing device can generate the history report associated with the identification number and the asset. The history report can comprise the first transaction from the first block, as well as any and all blocks in the asset blockchain ledger associated with the asset. Alternatively, or in addition, the computing device can dynamically transmit the generated history report to the first participant. In other words, the computing device can transmit the generated history report without receiving a request. In such a manner, the computing device can keep participants apprised of changes to the history report. The method 300 can terminate after block 345; however, in some examples, the method 300 can proceed to other method steps not shown, other methods disclosed herein, and/or other blocks of the method 300.

As used herein, the terms “component” and “system,” as well as various forms thereof (e.g., components, systems, sub-systems . . . ) are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The conjunction “or” as used in this description and appended claims is intended to mean an inclusive “or” rather than an exclusive “or,” unless otherwise specified or clear from context.

In other words, “‘X’ or ‘Y’” is intended to mean any inclusive permutations of “X” and “Y.” For example, if “‘A’ employs ‘X,’” “‘A employs ‘Y,’” or “'A′ employs both ‘X’ and ‘Y,’” then “‘A’ employs ‘X’ or ‘Y’” is satisfied under any of the foregoing instances.

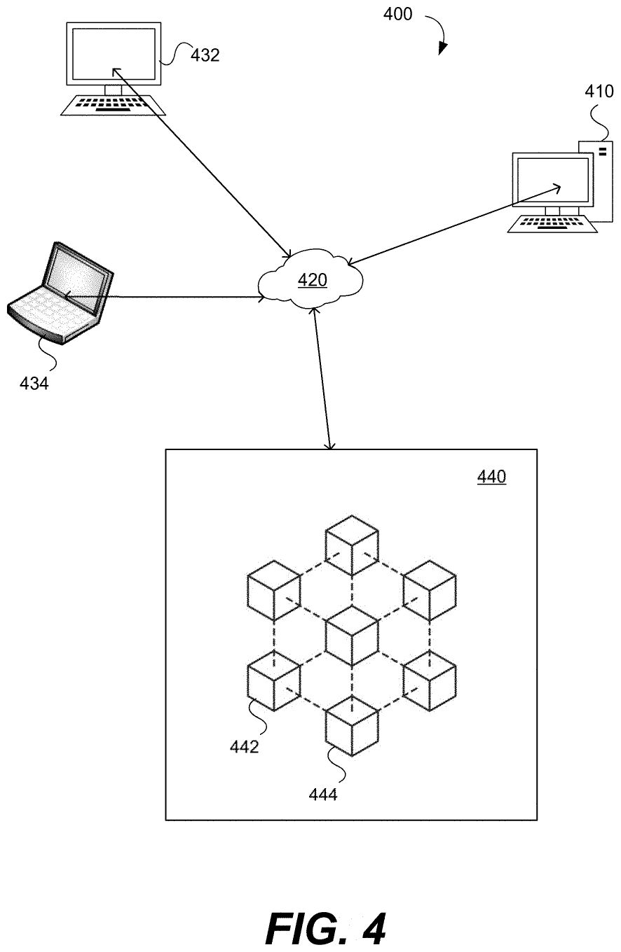

To provide a context for the disclosed subject matter, FIG. 4 as well as the following discussion are intended to provide a brief, general description of a suitable environment in which various aspects of the disclosed subject matter can be implemented. The suitable environment, however, is solely an example and is not intended to suggest any limitation as to scope of use or functionality.

While the above disclosed system and methods can be described in the general context of computer-executable instructions of a program that runs on one or more computers, those skilled in the art will recognize that aspects can also be implemented in combination with other program modules or the like. Generally, program modules include routines, programs, components, data structures, among other things that perform particular tasks and/or implement particular abstract data types. Moreover, those skilled in the art will appreciate that the above systems and methods can be practiced with various computer system configurations, including single-processor, multi-processor or multi-core processor computer systems, minicomputing devices, server computers, as well as personal computers, hand-held computing devices (e.g., personal digital assistant (PDA), smart phone, tablet, watch), microprocessor-based or programmable consumer or industrial electronics, and the like. Aspects can also be practiced in distributed computing environments where tasks are performed by remote processing devices that are linked through a communications network. However, some, if not all aspects, of the disclosed subject matter can be practiced on stand-alone computers. In a distributed computing environment, program modules may be located in one or both of local and remote memory devices. Aspects may also be practiced in a server-less computing environment.

With reference to FIG. 4, illustrated is an example environment of a system 400 for tracking equipment lifetimes. The methods described above in FIGS. 1-3 can be implemented by the system described in FIG. 4. However, it is understood that the methods described herein can be implemented by other computing devices, general purposes computers, and the like, not shown herein.

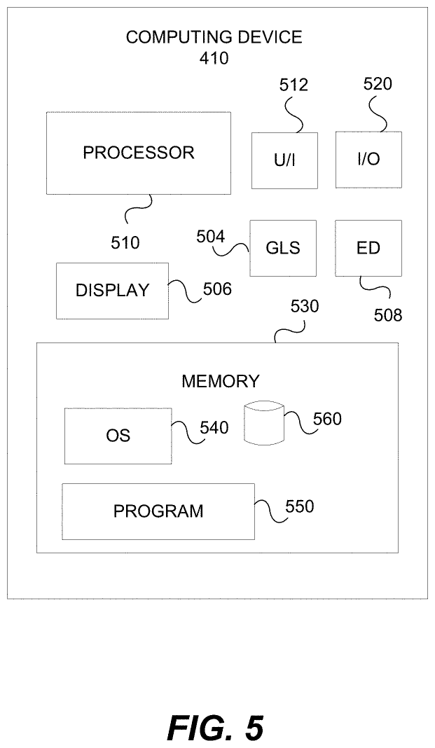

As shown, the system 400 can comprise a computing device 410 (e.g., desktop, laptop, tablet, watch, server, hand-held, programmable consumer or industrial electronics, set-top box, game system, compute node). The computing device 410 is shown and described in greater detail in FIG. 5. The computing device 410 can include or otherwise interact with a variety of computer-readable media to facilitate control of the computing device to implement one or more aspects of the disclosed subject matter. The computer-readable media can be any available media that is accessible to the computing device 410 and includes volatile and nonvolatile media, and removable and non-removable media. Computer-readable media can comprise two distinct and mutually exclusive types, namely storage media and communication media.

Storage media includes volatile and nonvolatile, removable, and nonremovable media implemented in any method or technology for storage of information such as computer-readable instructions, data structures, program modules, or other data. Storage media includes storage devices such as memory devices (e.g., random access memory (RAM), read-only memory (ROM), electrically erasable programmable read-only memory (EEPROM)), magnetic storage devices (e.g., hard disk, floppy disk, cassettes, tape), optical disks (e.g., compact disk (CD), digital versatile disk (DVD)), and solid state devices (e.g., solid state drive (SSD), flash memory drive (e.g., card, stick, key drive)), or any other like mediums that store, as opposed to transmit or communicate, the desired information accessible by the computing device 410. Accordingly, storage media excludes modulated data signals as well as that described with respect to communication media.

The computing device 410 can also include communication connection(s) to enable communication with at least a first computing device 432 and a second computing device 434 by means of a blockchain network 420. In some examples, the first computing device 432 and the second computing device 434 can be associated with a first participant and a second participant in the blockchain network 420, respectively. The communication connection(s) can include wired or wireless communication mechanisms to support network communication. The blockchain network 420 can correspond to a local area network (LAN) or a wide area network (WAN) such as the Internet. The first computing device 432 and the second computing device 434 can be another processor-based device with which the computing device 410 can interact. For example, the computing device 410 can correspond to a server that executes functionality of methods described herein, and the first computing device 432 can be a user device of a service technician that communicates and interacts with the computing device 410.

The blockchain network 420 and/or the computing device 410 can generate and generally maintain a blockchain asset ledger 440. As described above, when transactions concerning an asset are performed in the blockchain network 420 (or by participants in the blockchain network 420), the transaction data can be stored in blocks of the asset blockchain ledger 440 associated with that asset, such as in a first block 442 or in a second block 444.

An example embodiment of a computing device 410 is shown in more detail in FIG. 5. While FIG. 5 is illustrated and described with respect to the computing device 410, it is to be understood that the example is merely illustrative, and that the illustrations within FIG. 5 can comprise one or more additional components of the system 400 that would be understood by one of ordinary skill in the art.

As shown, the computing device 410 can include a processor 510; an I/O device 520; a memory 530 containing an OS 540; a storage device 560, which can be any suitable repository of data; and a program 550. In some examples, the computing device 410 can include components such as an accelerometer; a gyroscope; a GLS 504 for determining the geographic location of the computing device 410; a display 506 for displaying content such as text messages, images, and selectable buttons/icons/links; an environmental data (“ED”) sensor 508 for obtaining environmental data including audio and/or visual information; a U/I device 512 for receiving user input data, such as data representative of a click, a scroll, a tap, a press, or typing on an input device that can detect tactile inputs; a display; a microphone and/or an image capture device, such as a digital camera. In some examples, the computing device 410 can include a transceiver to communicate with the blockchain network 420 and/or other components of the system 400. In some examples, the computing device 410 can further include a peripheral interface, a mobile network interface in communication with the processor 510, a bus configured to facilitate communication between the various components of the computing device 410, and/or a power source configured to power one or more components of the computing device 410.

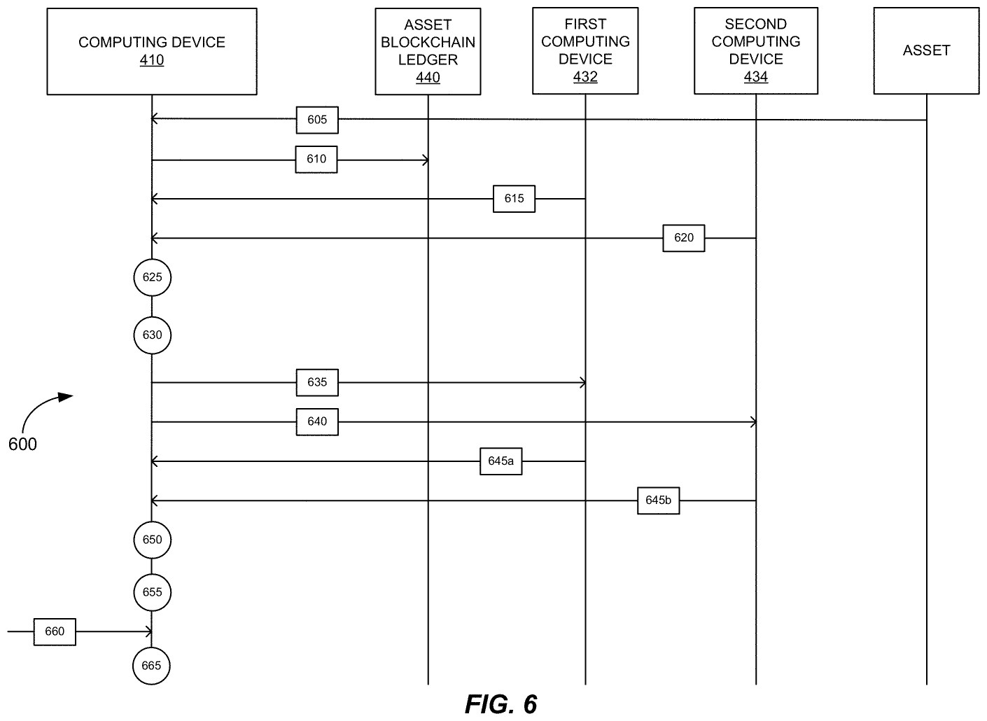

FIG. 6 illustrates a timing diagram for the method illustrated in FIG. 1. As shown, the computing device 410 can receive 605 an indication of an asset. Then, the computing device 410 can generate 610 an asset blockchain ledger 440 over or as part of the blockchain network 420. The asset blockchain ledger 440 can be associated with an identification number of the asset.

The computing device 410 can then receive 615 first data indicative of a first transaction corresponding to the asset from a first computing device 432 associated with a first participant in the blockchain network. The computing device can also receive 620 second data indicative of the first transaction from a second computing device 434 associated with a second participant. The computing device 410 can then generate 625 a first block 442 associated with the first transaction in the asset blockchain ledger 440. The first block 442 can also be associated with the identification number.

The computing device 410 can then determine 630 a first set of permissions associated with the first participant and a second set of permissions associated with the second participant. Then, the computing device can transmit 635, based at least in part on the first set of permissions, a request to the first computing device 432. The request can be for a first unreceived information from the first participant relating to the first transaction. The computing device 410 can also transmit 640, based at least in part on the second set of permissions, a request to the second computing device 434. The request can be for a second unreceived information from the second participant relating to the first transaction.

The computing device 410 can then receive 645a and 645b data representative of a response to the request for the first and the second unreceived information from the first computing device 432 and the second computing device 434, respectively. The computing device 410 can then determine 650 that the data representative of the response received from the first participant and the second participant comprises the first and the second unreceived information, respectively. In response, the computing device can write 655, in the blockchain network 420, the first transaction to the first block 442 of the asset blockchain ledger 440. The first block 442 can comprise participation data from the first and the second participants and the data representative of the response. The computing device 410 can then receive 660 a request for a history report associated with at least one of either the identification number or the asset. In response, the computing device 410 can generate 665 the history report, and the history report can comprise the first transaction.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims.

What is claimed is:

1. A method of tracking equipment lifetimes, the method comprising:
responsive to receiving an indication of an asset, generating, by a computing device, an asset blockchain ledger in a blockchain network, the asset blockchain ledger associated with an identification number;
receiving, at the computing device and from a first computing device associated with a first participant, first data indicative of a first transaction corresponding to the asset;
receiving, from a second computing device associated with a second participant, second data indicative of the first transaction corresponding to the asset;
generating, by the computing device and in the asset blockchain ledger associated with the identification number, a first block associated with the first transaction;
determining, by the computing device, a first set of permissions associated with the first participant and a second set of permissions associated with the second participant;
transmitting, from the computing device and based at least in part on the first set of permissions, and to the first computing device, a request for a first unreceived information from the first participant relating to the first transaction;
transmitting, from the computing device and based at least in part on the second set of permissions, and to the second computing device, a request for a second unreceived information from the second participant relating to the first transaction;
receiving, at the computing device, and from the first computing device and the second computing device, data representative of a response to the request for the first and the second unreceived information from each of the first participant and the second participant, respectively;
responsive to determining that the data representative of the response received from the first participant and the second participant comprises the first and the second unreceived information, respectively, writing, in the blockchain network, the first transaction to the first block of the asset blockchain ledger, the first block comprising participation data and the data representative of the response;
receiving, at the computing device, a request for a history report associated with at least one of the identification number or the asset; and
generating the history report associated with the identification number and the asset, the history report comprising the first transaction.

2. The method of claim 1, wherein the first transaction comprises one of: a product sale, a product maintenance, a product install, a product removal, or a product modification.

3. The method of claim 1, wherein the first transaction further comprises one of: a product valuation, a product warranty, a product service record, or a product service agreement.

4. The method of claim 1, wherein the first participant and the second participant are selected from one or more of: a manufacturer, a distributor, a shipper, a service agent, a storage entity, a dealer, an installer, or an owner.

5. The method of claim 1, further comprising:
receiving location data for the first transaction;
generating, by the computing device and in the asset blockchain ledger associated with the identification number, a second block associated with the first transaction; and
writing the location data to the second block of the asset blockchain ledger, wherein the second block comprises an indication that the location data is associated with the first block.

6. The method of claim 1, further comprising:
determining that the data representative of the response to request for the first unreceived information and the second unreceived information do not match;
transmitting an error message to each of the first participant and the second participant, the error message comprising the identification number, the first data, and the second data from the first transaction;
receiving, at the computing device, and from the first computing device and the second computing device, data representative of a response to the error message from each of the first participant and the second participant; and
responsive to determining that the response to the error message received from the first participant and the second participant matches, writing, in the blockchain network, the response to the error message to the first block of the asset blockchain.

7. The method of claim 1, further comprising updating the second set of permissions corresponding to the second participant, wherein the update comprises an indication that the second participant is the most recent owner of the asset.

8. The method of claim 1, wherein the request for the first unreceived information and the request for the second unreceived information each comprises a prompt for each of the first participant and the second participant to scan a code on the asset, the code representative of the identification number.

9. The method of claim 1, further comprising dynamically transmitting the generated history report to each of the first participant and the second participant.

10. A method for tracking equipment lifetimes, the method comprising:
responsive to receiving an indication of an asset, generating, by a computing device, an asset blockchain ledger in a blockchain network, the asset blockchain ledger associated with an identification number;
receiving, at the computing device and from a first computing device associated with a first participant, first data indicative of a first transaction corresponding to the asset;
generating, by the computing device and in the asset blockchain ledger associated with the identification number, a first block associated with the first transaction;
determining, by the computing device, a first set of permissions associated with the first participant;
transmitting, by the computing device and based at least in part on the first set of permissions, and to the first computing device, a request for a first unreceived information from the first participant relating to an activity being completed by the first participant;
receiving, at the computing device, and from the first computing device, an indication from the first participant that the first unreceived information has been received and the activity is complete;
responsive to receiving the first unreceived information, writing, in the blockchain network, the first transaction and the activity to a first block of the asset blockchain;
receiving, at the computing device, a request for a history report associated with the identification number and the asset; and
generating the history report associated with the identification number and the asset, the history report comprising the first transaction and the activity.

11. The method of claim 10, further comprising:
receiving location data for the first transaction;
generating, by the computing device and in the asset blockchain ledger associated with the identification number, a second block associated with the first transaction; and
writing the location data to the second block of the asset blockchain ledger, wherein the second block comprises an indication that the location data is associated with the first block.

12. The method of claim 10, further comprising responsive to receiving the first unreceived information, sending a confirmation request to the first participant, the confirmation request including a prompt for evidence from the first participant.

13. The method of claim 12, wherein the prompt for evidence comprises a prompt for one or more of: a photograph of the asset, a signature from the first participant, a voice recording from the first participant, a video of actions performed, or a document scan of the activity.

14. The method of claim 10, further comprising:
determining that the activity of the first transaction in the first block is incomplete; and
generating a second block in the asset blockchain, the second block comprising an indication of a correction to the first block.

15. The method of claim 10, further comprising receiving an indication from the first participant of a corrective action implemented on the asset, the corrective action comprising one or more of: replacing a part, restarting a component, resetting a component, restarting the asset, shutting down the asset, or recalibrating a part.

16. A method for generating equipment history reports, the method comprising:
responsive to receiving an indication of an asset, generating, by a computing device, an asset blockchain ledger in a blockchain network, the asset blockchain ledger associated with an identification number;
receiving, at the computing device and from a first computing device associated with a first participant, first data indicative of a first transaction corresponding to the asset;
generating, by the computing device and in the asset blockchain ledger associated with the identification number, a first block associated with the first transaction;
determining, by the computing device, a first set of permissions associated with the first participant;
transmitting, by the computing device and based at least in part on the first set of permissions, and to the first computing device, a list of required activities to the first participant, the list of required activities indicative of actions to be performed on the asset by the first participant;
receiving, at the computing device, and from the first computing device, an indication from the first participant of a corrective action implemented on the asset;
receiving, at the computing device, and from the first computing device, an indication from the first participant that the list of required activities has been fulfilled and the first transaction is complete;
responsive to determining that the indication fulfills the list of required activities, writing, in the blockchain network, the first transaction, the corrective action, and the list of activities to a first block of the asset blockchain ledger;
receiving, at the computing device, a request for a history report associated with the identification number and the asset; and
generating the history report associated with the identification number and the asset, the history report comprising the first transaction, the corrective action, and the list of activities.

17. The method of claim 16, further comprising responsive to receiving the indication that the list of required activities has been fulfilled, sending a confirmation request to the first participant, the confirmation request including a prompt for evidence from the first participant.

18. The method of claim 17, wherein the prompt for evidence comprises a prompt for one or more of: a photograph of the asset, a signature from the first participant, a voice recording from the first participant, a video of the actions performed, or a document scan of the list of required activities.

19. The method of claim 16, wherein the corrective action comprises one or more of: replacing a part, restarting a component, resetting a component, restarting the asset, shutting down the asset, or recalibrating a part.

20. The method of claim 16, further comprising:
receiving location data for the first transaction;
generating, by the computing device and in the asset blockchain ledger associated with the identification number, a second block associated with the first transaction; and
writing the location data to the second block of the asset blockchain ledger, wherein the second block comprises an indication that the location data is associated with the first block.
